(19) United States
(12) Patent Application Publication
(10) Pub. No.: US 2026/0038915 A1
(43) Pub. Date: Feb. 5, 2026

(54) THERMAL BARRIER SYSTEMS FOR USE WITHIN TRACTION BATTERY PACKS

(71) Applicant: FORD GLOBAL TECHNOLOGIES, LLC, Dearborn, MI (US)

(72) Inventors: Bhaskara Rao Boddakayala, Troy, MI (US); Di Zhu, Novi, MI (US)

(21) Appl. No.: 19/271,886

(22) Filed: Jul. 17, 2025

Related U.S. Application Data
(60) Provisional application No. 63/679,332, filed on Aug. 5, 2024.

(51) Int. Cl. H01M 10/658; H01M 10/625; H01M 50/211; H01M 50/242; H01M 50/249; H01M 50/293

(52) U.S. Cl. CPC H01M 10/658; H01M 10/625; H01M 50/242; H01M 50/249; H01M 50/293; H01M 50/211

(57) ABSTRACT

Thermal barrier systems are provided for inhibiting the transfer of thermal energy inside a traction battery pack. An exemplary thermal barrier system may include one or more thermal barrier assemblies arranged between adjacent battery cell groups of a cell stack. Each thermal barrier assembly may include a mica core, a first ceramic foam layer, a second ceramic foam layer, a first glass silicone layer, and a second glass silicone layer. In some implementations, the thermal barrier system may additionally include one or more cell expansion pad assemblies and/or one or more thermal barriers.

### CROSS REFERENCE TO RELATED APPLICATIONS

This application claims the benefit of U.S. Provisional Application No. 63/679,332, which was filed on Aug. 5, 2024 and is incorporated herein by reference in its entirety.

### TECHNICAL FIELD

This disclosure relates generally to traction battery packs, and more particularly to thermal barrier systems for managing the transfer of thermal energy within traction battery packs.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A traction battery pack according to an exemplary aspect of the present disclosure includes, among other things, a cell stack including a first battery cell group, a second battery cell group, and a thermal barrier assembly arranged to limit heat transfer between the first battery cell group and the second battery cell group. The thermal barrier assembly includes a mica core, a first ceramic foam layer, a second ceramic foam layer, a first glass silicone layer, and a second glass silicone layer.

In a further non-limiting embodiment of the foregoing traction battery pack, the cell stack includes a cell expansion pad assembly arranged between the first battery cell group and an end plate.

In a further non-limiting embodiment, of the foregoing traction battery packs, the cell expansion pad assembly includes a ceramic foam layer sandwiched between a third glass silicone layer and a fourth glass silicone layer.

In a further non-limiting embodiment, of the foregoing traction battery packs, the cell stack includes a thermal barrier arranged between the second battery cell group and a third battery cell group.

In a further non-limiting embodiment, of the foregoing traction battery packs, the thermal barrier includes a ceramic foam.

In a further non-limiting embodiment, of the foregoing traction battery packs, the first battery cell group and the second battery cell group each include at least two battery cells.

In a further non-limiting embodiment, of the foregoing traction battery packs, the mica core is sandwiched between the first ceramic foam layer and the second ceramic foam layer.

In a further non-limiting embodiment, of the foregoing traction battery packs, the first glass silicone layer flanks the first ceramic foam layer, and the second glass silicone layer flanks the second ceramic foam layer.

In a further non-limiting embodiment, of the foregoing traction battery packs, the multi-layered thermal barrier assembly includes a thickness of about 2.0 mm.

In a further non-limiting embodiment, of the foregoing traction battery packs, the mica core includes a thickness of about 0.3 mm, the first and second ceramic foam layers each include a thickness of about 0.65 mm, and the first and second glass silicone layers each include a thickness of about 0.2 mm.

In a further non-limiting embodiment, of the foregoing traction battery packs, the multi-layered thermal barrier assembly includes a thickness of about 3.0 mm.

In a further non-limiting embodiment, of the foregoing traction battery packs, the mica core includes a thickness of about 0.8 mm, the first and second ceramic foam layers each include a thickness of about 0.9 mm, and the first and second glass silicone layers each include a thickness of about 0.2 mm.

In a further non-limiting embodiment, of the foregoing traction battery packs, the multi-layered thermal barrier assembly includes a thickness of about 4.0 mm.

In a further non-limiting embodiment, of the foregoing traction battery packs, the mica core includes a thickness of about 1.2 mm, the first and second ceramic foam layers each include a thickness of about 1.2 mm, and the first and second glass silicone layers each include a thickness of about 0.2 mm.

In a further non-limiting embodiment, of the foregoing traction battery packs, the multi-layered thermal barrier assembly includes a thickness of about 2.9 mm.

In a further non-limiting embodiment, of the foregoing traction battery packs, the mica core includes a thickness of about 0.5 mm, the first and second ceramic foam layers each include a thickness of about 1.0 mm, and the first and second glass silicone layers each include a thickness of about 0.2 mm.

The embodiments, examples, and alternatives of the preceding paragraphs, the claims, or the following description and drawings, including any of their various aspects or respective individual features, may be taken independently or in any combination. Features described in connection with one embodiment are applicable to all embodiments unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 illustrates a traction battery pack of the electrified vehicle of FIG. 1.

FIG. 3 illustrates a cell stack of the traction battery pack of FIG. 2.

FIG. 4 is a blown-up view of select portions of the cell stack of FIG. 3.

FIG. 5 is an exploded view of an exemplary cell expansion pad assembly of a thermal barrier system.

FIG. 6 is an exploded view of an exemplary multi-layered thermal barrier assembly of a thermal barrier system.

FIG. 7 is an exploded view of select portions of a cell stack of a traction battery pack.

FIG. 8 is an exploded view of select portions of another exemplary cell stack of a traction battery pack.

### DETAILED DESCRIPTION

This disclosure details thermal barrier system for inhibiting the transfer of thermal energy inside a traction battery pack. An exemplary thermal barrier system may include one or more thermal barrier assemblies arranged between adjacent battery cell groups of a cell stack. Each thermal barrier assembly may include a mica core, a first ceramic foam layer, a second ceramic foam layer, a first glass silicone layer, and a second glass silicone layer. In some implementations, the thermal barrier system may additionally include one or more cell expansion pad assemblies and/or one or more thermal barriers. These and other features are discussed in greater detail in the following paragraphs of this detailed description.

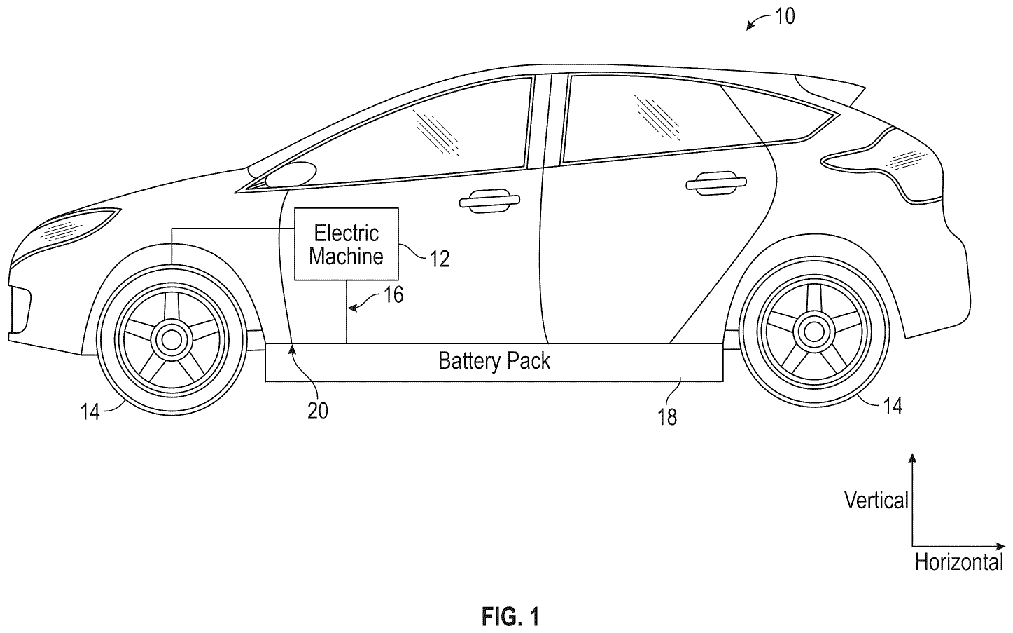

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In an embodiment, the electrified vehicle 10 is a full electric vehicle propelled solely through electric power, such as by one or more electric machines 12, without any assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cell groupings capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

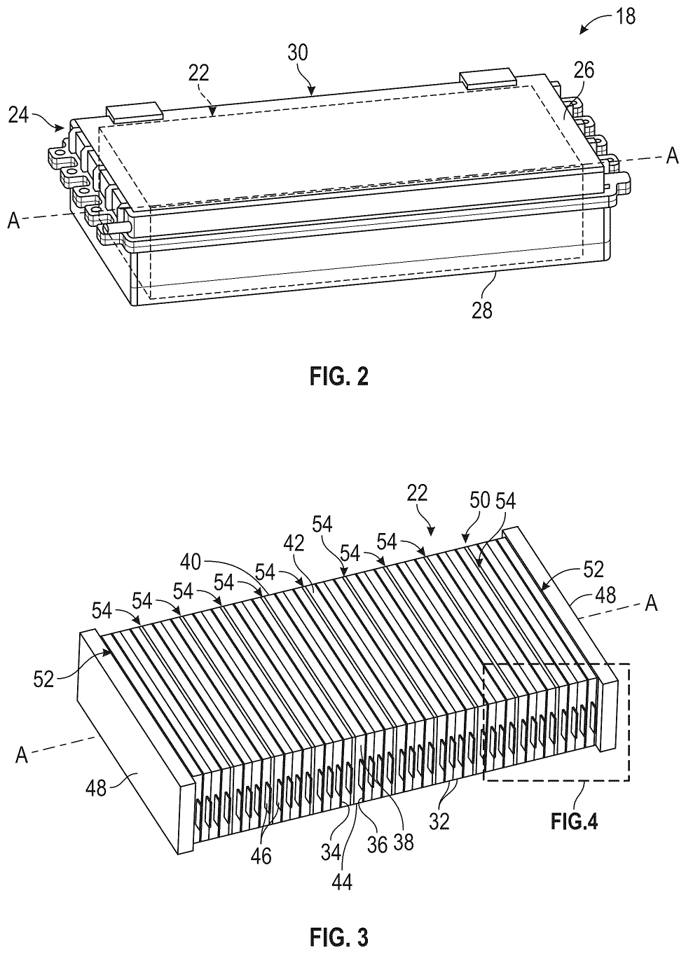

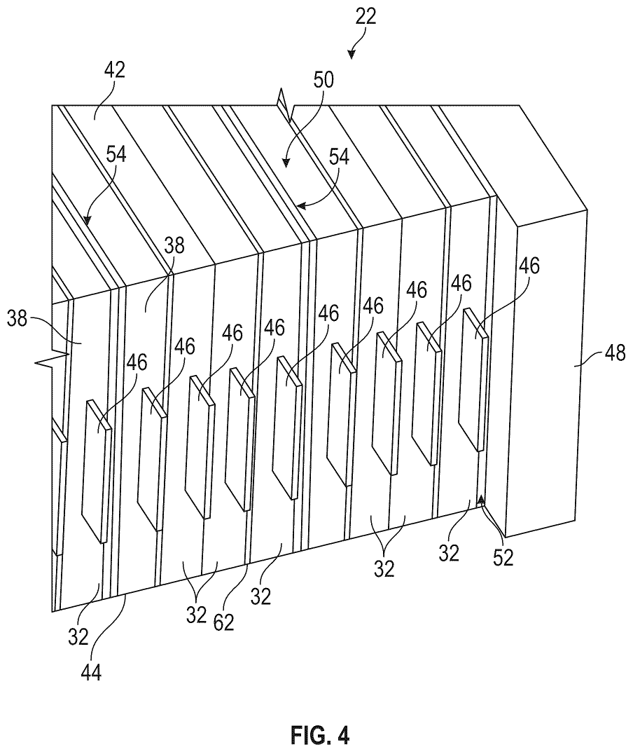

FIGS. 2, 3, and 4 illustrate additional details associated with the traction battery pack 18 of the electrified vehicle 10. The traction battery pack 18 may include one or more cell stacks 22 (e.g., one shown) housed within an interior area 30 of an enclosure assembly 24. The enclosure assembly 24 of the traction battery pack 18 may include an enclosure cover 26 and an enclosure tray 28. The enclosure cover 26 may be positioned vertically above the enclosure tray 28. However, the enclosure cover 26 could be arranged below or to a side of the enclosure tray 28. Various terms such as “above,” “below,” “top,” and “bottom” are used relative to the arrangement of the components of the traction battery pack 18 in the various drawings and should not otherwise be deemed limiting. These terms are with reference to the general orientation of the traction battery pack 18 when installed on the electrified vehicle 10 of FIG. 1. Vertical, for purposes of this disclosure, is also with reference to ground and how the traction battery pack 18 is oriented when installed on the electrified vehicle 10.

The enclosure cover 26 may be secured (e.g., bolted, welded, adhered, etc.) to the enclosure tray 28 to provide the interior area 30 for housing the cell stacks 22 and other battery internal components (e.g., busbars, control modules and other electronics, etc.) of the traction battery pack 18. The size, shape, and overall configuration of the enclosure assembly 24 may vary within the scope of this disclosure.

Each cell stack 22 may include a plurality of individual battery cells 32 that are arranged together along a cell stack axis A between opposing end plates 48. The battery cells 32 store and supply electrical power for powering various components in order to support electric propulsion of the electrified vehicle 10.

In an embodiment, the battery cells 32 are lithium-ion pouch cells. However, battery cells having other geometries (prismatic, cylindrical, etc.) and/or chemistries (nickel-metal hydride, lead-acid, etc.) could alternatively be utilized within the scope of this disclosure.

Although a specific number of cell stacks 22 and battery cells 32 are illustrated in the various figures of this disclosure, the traction battery pack 18 could include any number of the cell stacks 22, with each cell stack 22 having any number of individual battery cells 32.

Each battery cell 32 may include a first face 34, a second face 36 opposite the first face 34, a first end 38, a second end 40 opposite the first end 38, a top side 42, and a bottom side 44 opposite the top side 42. The first face 34 and the second face 36 establish major side surfaces of the battery cells 32, and the first end 38, the second end 40, the top side 42, and the bottom side 44 establish minor side surfaces of the battery cell 32. The first face 34 and the second face 36 therefore exhibit a greater surface area than any of the first end 38, the second end 40, the top side 42, and the bottom side 44.

A tab terminal 46 may project outwardly from each of the first end 38 and the second end 40 of the battery cells 32. The battery cells 32 may thus be considered to be “side-oriented” within the cell stacks 22. The tab terminals 46 may be connected to busbars (not shown) in order to electrically connect the battery cells 32 of each cell stack 22.

The cell stack 22 may additionally include a thermal barrier system 50 adapted for managing the transfer of thermal energy across the cell stack 22. The thermal barrier system 50 may include one or more cell expansion pad assemblies 52 and one or more multi-layered thermal barrier assemblies 54.

In an embodiment, the cell stack 22 includes a pair of cell expansion pad assemblies 52. One cell expansion pad assembly 52 may be arranged between a first of the end plates 48 and the battery cells 32 of the cell stack 22, and another cell expansion pad assembly 52 may be arranged between a second of the end plates 48 and the battery cells 32 of the cell stack 22.

One or more of the multi-layered thermal barrier assemblies 54 may be arranged along the respective cell stack axis A of each cell stack 22. In an embodiment, groups of four individual battery cells 32 are separated by thermal barrier assemblies 54 along the cell stack axis A. In other implementations, groups of two, three, or six battery cells 32 may be separated by multi-layered thermal barrier assemblies 54 along the cell stack axis A. However, other configurations are contemplated within the scope of this disclosure, and it should be apparent those having the benefit of this disclosure that the cell stack 22 could include any number of and arrangement of battery cells 32, cell expansion pad assemblies 52, and thermal barrier assemblies 54.

The battery cells 32 may be arranged such that the faces 34, 36 of one battery cell 32 are in direct contact with one of the faces 34 or 36 of a neighboring battery cell 32, of a neighboring multi-layered thermal barrier assembly 54 of the cell stack 22, or of a neighboring cell expansion pad assembly 52 of the cell stack 22. The battery cells 32, thermal barrier assemblies 54, and cell expansion pad assemblies 52 may be held in compression relative to one another within the cell stack 22 to provide the face-to-face arrangement. The compression may be applied by the end plates 48 of the cell stack 22, for example. However, other configurations are contemplated within the scope of this disclosure.

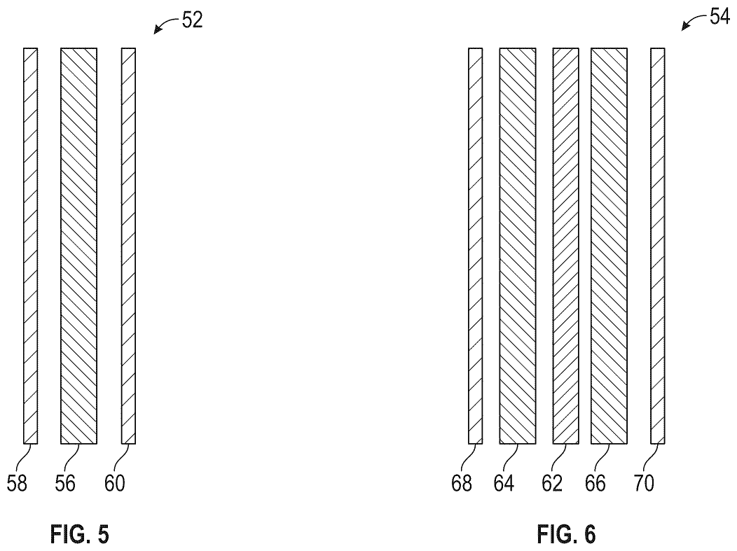

Referring now primarily to FIG. 5, each cell expansion pad assembly 52 of the thermal barrier system 50 may be configured as a multi-layered structure that is configured to both accommodate battery cell swelling and limit the conductive heat transfer of thermal energy across the cell stack 22. Each cell expansion pad assembly 52 may include a ceramic foam layer 56 sandwiched between a first glass silicone layer 58 and a second glass silicone layer 60. The ceramic foam layer 56 and the first and second glass silicone layers 58, 60 may be bonded or otherwise secured together to form an integrated unit using any known technique.

The ceramic foam layer 56 may include a ceramic material(s) (e.g., silica, etc.) that can function to accommodate battery cell swelling. The first glass silicone layer 58 and the second glass silicone layer 60 may each include intumescent materials that can activate in response to a thermal event in one or more battery cells 32 when a temperature at or near the cell stack 22 exceeds a predefined temperature threshold (e.g., about 200° C.). Once activated, the intumescent materials, which are endothermic, can absorb heat energy created during the thermal event and can contain some portion of convection effects of hot gasses to minimize thermal influence on neighboring battery cells 32 and/or neighboring cell stacks 22 of the traction battery pack 18.

In an embodiment, a total thickness (e.g., a dimension extending in parallel with the length of the cell stack 22 along the cell stack axis A) of each cell expansion pad assembly 52 is about 1.7 mm, with the ceramic foam layer 56 having a thickness of about 1.3 mm and the first and second glass silicone layers 58, 60 each having a thickness of about 0.2 mm. However, other thicknesses are contemplated within the scope of this disclosure. In this disclosure, the term “about” means that the expressed quantities or ranges need not be exact but may be approximated and/or larger or smaller, reflecting acceptable tolerances, conversion factors, measurement error, etc.

Referring now to FIG. 6, each multi-layered thermal barrier assembly 54 of the thermal barrier system 50 may be configured as a multi-layered structure that is configured to limit the conductive heat transfer of thermal energy across the cell stack 22. For example, the multi-layered thermal barrier assemblies 54 may be arranged to limit the conductive cell-to-cell transfer of thermal energy across each cell stack 22 of the traction battery pack 18.

The multi-layered structure of each multi-layered thermal barrier assembly 54 may include a mica core 62, a first ceramic foam layer 64, a second ceramic foam layer 66, a first glass silicone layer 68, and a second glass silicone layer 70. The mica core 62, the first ceramic foam layer 64, the second ceramic foam layer 66, the first glass silicone layer 68, and the second glass silicone layer 70 may be bonded or otherwise secured together to form an integrated unit using any known technique. The mica core 62 may be sandwiched between the first ceramic foam layer 64 and the second ceramic foam layer 66. The first glass silicone layer 68 may flank the first ceramic foam layer 64, and the second glass silicone layer 70 may flank the second ceramic foam layer 66.

The mica core 62 is a thermally resistant structure that is configured to provide an effective barrier from cell particle effluents during battery thermal events. The first and second ceramic foam layers 64, 66 may include a ceramic material(s) (e.g., silica, etc.) that is configured to help dissipate thermal energy and to distribute thermal energy across the first and second glass silicone layers 68, 70 to help endothermically activate these layers during the thermal event.

The first glass silicone layer 68 and the second glass silicone layer 70 may each include intumescent materials that can activate in response to a thermal event in one or more of the battery cells 32 when a temperature exceeds a predefined temperature threshold (e.g., about 200° C.). Once activated, the intumescent materials, which are endothermic, can absorb heat energy during the thermal event and can contain some portion of convection effects of hot gasses to minimize thermal influence on neighboring battery cells 32 within the cell stack 22.

In an embodiment, a total thickness (e.g., a dimension extending in parallel with the length of the cell stack 22 along the cell stack axis A) of each multi-layered thermal barrier assembly 54 is about 2.0 mm, with the mica core 62 having a thickness of about 0.3 mm, the first and second ceramic foam layers 64, 66 each having a thickness of about 0.65 mm, and the first and second glass silicone layers 68, 70 each having a thickness of about 0.2 mm.

In yet another embodiment, a total thickness of each multi-layered thermal barrier assembly 54 is about 2.9 mm, with the mica core 62 having a thickness of about 0.5 mm, the first and second ceramic foam layers 64, 66 each having a thickness of about 1.0 mm, and the first and second glass silicone layers 68, 70 each having a thickness of about 0.2 mm.

In another embodiment, a total thickness of each multi-layered thermal barrier assembly 54 is about 3.0 mm, with the mica core 62 having a thickness of about 0.8 mm, the first and second ceramic foam layers 64, 66 each having a thickness of about 0.9 mm, and the first and second glass silicone layers 68, 70 each having a thickness of about 0.2 mm.

In yet another embodiment, a total thickness of each multi-layered thermal barrier assembly 54 is about 4.0 mm, with the mica core 62 having a thickness of about 1.2 mm, the first and second ceramic foam layers 64, 66 each having a thickness of about 1.2 mm, and the first and second glass silicone layers 68, 70 each having a thickness of about 0.2 mm.

The above examples are exemplary only, and other thicknesses are contemplated within the scope of this disclosure. The actual thickness of each layer of the multi-layered thermal barrier assemblies described herein can vary depending on the thermal requirements of the cell stack 22, among other factors.

Notably, although the thermal barrier system 50 is described above as having both the cell expansion pad assemblies 52 and the multi-layered thermal barrier assemblies 54, other thermal barrier system implementations, including those that omit the cell expansion pad assemblies 52, could be provided within the scope of this disclosure.

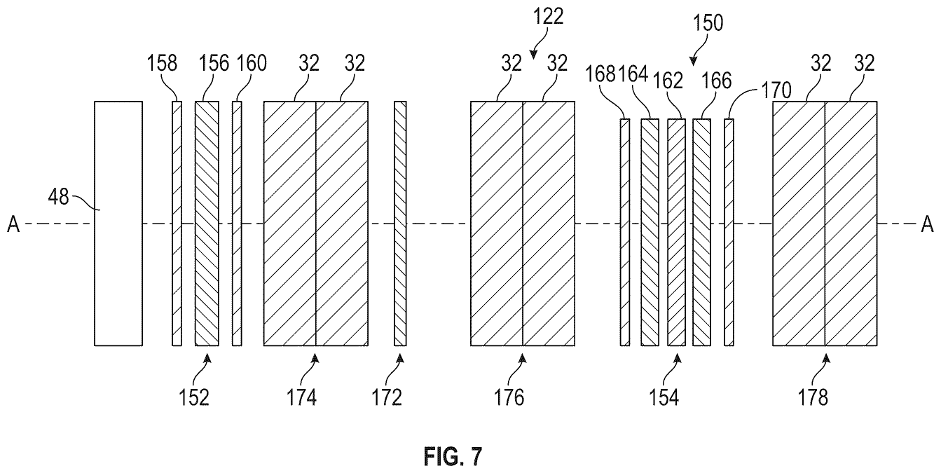

FIG. 7 illustrates select portions of another exemplary cell stack 122 that can be employed for use within a traction battery pack. The cell stack 122 may include a thermal barrier system 150 that is configured to manage the transfer of thermal energy across the cell stack 122. The thermal barrier system 150 may include one or more cell expansion pad assemblies 152, one or more multi-layered thermal barrier assemblies 154, and one or more thermal barriers 172.

The cell expansion pad assembly 152 may be arranged between an end plate 48 and a first battery cell group 174 of the cell stack 122. The first battery cell group 174 may include two or more battery cells 32. Although not shown in the highly schematic depiction of FIG. 7, an additional cell expansion pad assembly 152 could be arranged between a second end plate and another battery cell group of the cell stack 122.

The cell expansion pad assembly 152 may be configured as a multi-layered structure that is configured to both accommodate battery cell swelling and limit the conductive heat transfer of thermal energy across the cell stack 22. The cell expansion pad assembly 152 may include a ceramic foam layer 156 sandwiched between a first glass silicone layer 158 and a second glass silicone layer 160.

The ceramic foam layer 156 may include a ceramic material(s) (e.g., silica, etc.) that can function to accommodate battery cell swelling. The first glass silicone layer 158 and the second glass silicone layer 160 may each include intumescent materials that can activate in response to a thermal event in one or more battery cells 32 when a temperature exceeds a predefined temperature threshold (e.g., about 200° C.). Once activated, the intumescent materials, which are endothermic, can absorb thermal energy and contain some portion of convection effects of hot gasses to minimize thermal influence on neighboring battery cells 32 and/or neighboring cell stacks within the traction battery pack.

In an embodiment, a total thickness (e.g., a dimension extending in parallel with the length of the cell stack 122 along the cell stack axis A) of the cell expansion pad assembly 152 is about 1.7 mm, with the ceramic foam layer 156 having a thickness of about 1.3 mm and the first and second glass silicone layers 158, 160 each having a thickness of about 0.2 mm. However, other thicknesses are contemplated within the scope of this disclosure.

The multi-layered thermal barrier assembly 154 may be arranged between a second battery cell group 176 and a third battery cell group 178 of the cell stack 122. The second battery cell group 176 and the third battery cell group 178 may each include two or more battery cells 32. The multi-layered thermal barrier assembly 154 of the thermal barrier system 150 may be configured as a multi-layered structure that is configured to limit the conductive heat transfer of thermal energy across the cell stack 122. For example, the multi-layered thermal barrier assembly 154 may be arranged to limit the conductive transfer of thermal energy between the second and third battery cell groups 176, 178.

The multi-layered structure of each multi-layered thermal barrier assembly 154 may include a mica core 162, a first ceramic foam layer 164, a second ceramic foam layer 166, a first glass silicone layer 168, and a second glass silicone layer 170. The mica core 162 may be sandwiched between the first ceramic foam layer 164 and the second ceramic foam layer 166. The first glass silicone layer 168 may flank the first ceramic foam layer 164, and the second glass silicone layer 170 may flank the second ceramic foam layer 166.

The mica core 162 is a thermally resistant structure that is configured to provide an effective barrier from cell particle effluents during a thermal event. The first and second ceramic foam layers 164, 166 may include a ceramic material(s) (e.g., silica, etc.) that is configured to help dissipate thermal energy and to distribute thermal energy across the first and second glass silicone layers 168, 170 to help endothermically activate these layers during a thermal event.

The first glass silicone layer 168 and the second glass silicone layer 170 may each include intumescent materials that can activate in response to a thermal event in one or more of the battery cells 32 when a temperature exceeds a predefined temperature threshold (e.g., about 200° C.). Once activated, the intumescent materials, which are endothermic, can absorb heat energy during a thermal event and can contain some portion of convection effects of hot gasses to minimize any thermal effect on neighboring battery cells 32.

In an embodiment, a total thickness (e.g., a dimension extending in parallel with the length of the cell stack 122 along the cell stack axis A) of the multi-layered thermal barrier assembly 154 is about 3.0 mm, with the mica core 162 having a thickness of about 0.8 mm, the first and second ceramic foam layers 164, 166 each having a thickness of about 0.9 mm, and the first and second glass silicone layers 168, 170 each having a thickness of about 0.2 mm. However, other thicknesses are contemplated within the scope of this disclosure.

The thermal barrier 172 may be arranged between the first battery cell group 174 and the second battery cell group 176. The thermal barrier 172 of the thermal barrier system 150 may be configured as a single-layered structure that includes a ceramic foam for limiting the conductive heat transfer of thermal energy between the first battery cell group 174 and the second battery cell group 176.

In an embodiment, a total thickness (e.g., a dimension extending in parallel with the length of the cell stack 122 along the cell stack axis A) of the thermal barrier 172 is about 1.0 mm. However, other thicknesses are contemplated within the scope of this disclosure.

The above pattern of alternating between the thermal barrier 172 and the multi-layered thermal barrier assembly 154 may be repeated across the entire length of the cell stack 122. One of the multi-layered thermal barrier assemblies 154 may thus be arranged between every four battery cells 32 of the cell stack 122. An additional first thermal barrier assembly (not shown) may be positioned between the last battery cell grouping and the second end plate of the cell stack 122.

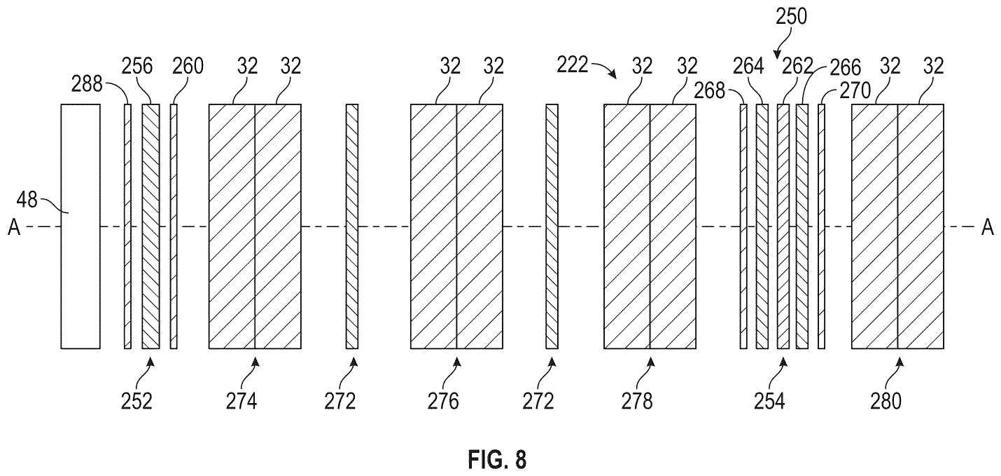

FIG. 8 illustrates select portions of another exemplary cell stack 222 that can be employed for use within a traction battery pack. The cell stack 222 may include a thermal barrier system 250 that is configured to manage the transfer of thermal energy across the cell stack 222. The thermal barrier system 250 may include one or more cell expansion pad assemblies 252, one or more multi-layered thermal barrier assemblies 254, and one or more thermal barriers 272.

The cell expansion pad assembly 252 may be arranged between an end plate 48 and a first battery cell group 274 of the cell stack 222. The first battery cell group 274 may include two or more battery cells 32. Although not shown in the highly schematic depiction of FIG. 8, an additional cell expansion pad assembly 252 could be arranged between a second end plate and another battery cell group of the cell stack 222.

The cell expansion pad assembly 252 may be configured as a multi-layered structure that is configured to both accommodate battery cell swelling and limit the conductive heat transfer of thermal energy across the cell stack 222. The cell expansion pad assembly 252 may include a ceramic foam layer 256 sandwiched between a first glass silicone layer 258 and a second glass silicone layer 260.

The ceramic foam layer 256 may include a ceramic material(s) (e.g., silica, etc.) that can function to accommodate battery cell swelling. The first glass silicone layer 258 and the second glass silicone layer 260 may each include intumescent materials that can activate in response to a thermal event in one or more battery cells 32 when a temperature exceeds a predefined temperature threshold (e.g., about 200° C.). Once activated, the intumescent materials, which are endothermic, can absorb thermal energy during a thermal event and can contain some portion of convection effects of hot gasses to minimize effect on neighboring battery cells 32 and/or neighboring cell stacks within the traction battery pack.

In an embodiment, a total thickness (e.g., a dimension extending in parallel with the length of the cell stack 222 along the cell stack axis A) of the cell expansion pad assembly 252 is about 1.7 mm, with the ceramic foam layer 256 having a thickness of about 1.3 mm and the first and second glass silicone layers 258, 260 each having a thickness of about 0.2 mm. However, other thicknesses are contemplated within the scope of this disclosure.

The multi-layered thermal barrier assembly 254 may be arranged between a third battery cell group 278 and a fourth battery cell group 280 of the cell stack 222. The third battery cell group 278 and the fourth battery cell group 280 may each include two or more battery cells 32. The multi-layered thermal barrier assembly 254 of the thermal barrier system 250 may be configured as a multi-layered structure that is configured to limit the conductive heat transfer of thermal energy across the cell stack 222. For example, the multi-layered thermal barrier assembly 254 may be arranged to limit the conductive transfer of thermal energy between the third and fourth battery cell groups 278, 280.

The multi-layered structure of each multi-layered thermal barrier assembly 254 may include a mica core 262, a first ceramic foam layer 264, a second ceramic foam layer 266, a first glass silicone layer 268, and a second glass silicone layer 270. The mica core 262 may be sandwiched between the first ceramic foam layer 264 and the second ceramic foam layer 266. The first glass silicone layer 268 may flank the first ceramic foam layer 264, and the second glass silicone layer 270 may flank the second ceramic foam layer 266.

The mica core 262 is a thermally resistant structure that is configured to provide an effective barrier from cell particle effluents during a thermal event. The first and second ceramic foam layers 264, 266 may include a ceramic material(s) (e.g., silica, etc.) that is configured to help dissipate thermal energy and to distribute thermal energy across the first and second glass silicone layers 268, 270 to help endothermically activate these layers during a thermal event.

The first glass silicone layer 268 and the second glass silicone layer 270 may each include intumescent materials that can activate in response to a thermal event in one or more of the battery cells 32 when a temperature exceeds a predefined temperature threshold (e.g., about 200° C.). Once activated, the intumescent materials, which are endothermic, can absorb heat energy during a thermal event and can contain some portion of convection effects of hot gasses to minimize effect on neighboring battery cells 32.

In an embodiment, a total thickness (e.g., a dimension extending in parallel with the length of the cell stack 222 along the cell stack axis A) of the multi-layered thermal barrier assembly 254 is about 4.0 mm, with the mica core 262 having a thickness of about 1.2 mm, the first and second ceramic foam layers 264, 266 each having a thickness of about 1.2 mm, and the first and second glass silicone layers 268, 270 each having a thickness of about 0.2 mm. However, other thicknesses are contemplated within the scope of this disclosure.

A first of the thermal barriers 272 may be arranged between the first battery cell group 274 and a second battery cell group 276, and a second of the thermal barriers 272 may be arranged between the second battery cell group 276 and the third battery cell group 278. The thermal barriers 272 of the thermal barrier system 250 may each be configured as a single-layered structure that includes a ceramic foam for limiting the conductive heat transfer of thermal energy between neighboring cell groups of the cell stack 222.

In an embodiment, a total thickness (e.g., a dimension extending in parallel with the length of the cell stack 122 along the cell stack axis A) of each thermal barrier 272 is about 1.0 mm. However, other thicknesses are contemplated within the scope of this disclosure.

The above pattern of alternatingly arranging two of the thermal barriers 272 and then one of the multi-layered thermal barrier assemblies 254 may be repeated across the entire length of the cell stack 222. One of the multi-layered thermal barrier assemblies 254 may thus be arranged between every six battery cells 32 of the cell stack 222. An additional cell expansion pad assembly (not shown) may be positioned between the last battery cell grouping and the second end plate of the cell stack 222.

The exemplary thermal barrier systems of this disclosure are configured to provide increased thermal insulation compared to known systems. The proposed thermal barrier systems can provide compartmentalization of vent gases using a unique combination of materials.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
a cell stack including a first battery cell group, a second battery cell group, and a multi-layered thermal barrier assembly arranged to limit a transfer of thermal energy between the first battery cell group and the second battery cell group,
wherein the multi-layered thermal barrier assembly includes a mica core, a first ceramic foam layer, a second ceramic foam layer, a first glass silicone layer, and a second glass silicone layer.

2. The traction battery pack as recited in claim 1, wherein the cell stack further includes a cell expansion pad assembly arranged between the first battery cell group and an end plate.

3. The traction battery pack as recited in claim 2, wherein the cell expansion pad assembly includes a ceramic foam layer sandwiched between a third glass silicone layer and a fourth glass silicone layer.

4. The traction battery pack as recited in claim 1, wherein the cell stack further includes a thermal barrier arranged between the second battery cell group and a third battery cell group.

5. The traction battery pack as recited in claim 4, wherein the thermal barrier includes a ceramic foam.

6. The traction battery pack as recited in claim 1, wherein the first battery cell group and the second battery cell group each include at least two battery cells.

7. The traction battery pack as recited in claim 1, wherein the mica core is sandwiched between the first ceramic foam layer and the second ceramic foam layer.

8. The traction battery pack as recited in claim 7, wherein the first glass silicone layer flanks the first ceramic foam layer, and the second glass silicone layer flanks the second ceramic foam layer.

9. The traction battery pack as recited in claim 1, wherein the multi-layered thermal barrier assembly includes a thickness of about 2.0 mm.

10. The traction battery pack as recited in claim 9, wherein the mica core includes a thickness of about 0.3 mm, the first and second ceramic foam layers each include a thickness of about 0.65 mm, and the first and second glass silicone layers each include a thickness of about 0.2 mm.

11. The traction battery pack as recited in claim 1, wherein the multi-layered thermal barrier assembly includes a thickness of about 3.0 mm.

12. The traction battery pack as recited in claim 11, wherein the mica core includes a thickness of about 0.8 mm, the first and second ceramic foam layers each include a thickness of about 0.9 mm, and the first and second glass silicone layers each include a thickness of about 0.2 mm.

13. The traction battery pack as recited in claim 1, wherein the multi-layered thermal barrier assembly includes a thickness of about 4.0 mm.

14. The traction battery pack as recited in claim 12, wherein the mica core includes a thickness of about 1.2 mm, the first and second ceramic foam layers each include a thickness of about 1.2 mm, and the first and second glass silicone layers each include a thickness of about 0.2 mm.

15. The traction battery pack as recited in claim 1, wherein the multi-layered thermal barrier assembly includes a thickness of about 2.9 mm.

16. The traction battery pack as recited in claim 12, wherein the mica core includes a thickness of about 0.5 mm, the first and second ceramic foam layers each include a thickness of about 1.0 mm, and the first and second glass silicone layers each include a thickness of about 0.2 mm.

17. A traction battery pack, comprising:
a first battery cell;
a second battery cell;
a multi-layered thermal barrier assembly arranged to limit a transfer of thermal energy between the first battery cell and the second battery cell; and
the multi-layered thermal barrier assembly includes a mica core, at least one ceramic foam layer, and at least one glass silicone layer.

18. The traction battery pack as recited in claim 17, wherein the at least one ceramic foam layer includes a first ceramic foam layer and a second ceramic foam layer, and the mica core is sandwiched between the first ceramic foam layer and the second ceramic foam layer.

19. The traction battery pack as recited in claim 18, wherein the at least one glass silicone layer includes a first glass silicone layer that is positioned to flank the first ceramic foam layer, and a second glass silicone layer that is positioned to flank the second ceramic foam layer.

20. The traction battery pack as recited in claim 17, wherein the at least one ceramic foam layer includes silica, and the at least one glass silicone layer includes an intumescent material.
